(19) United States
(12) Patent Application Publication
(10) Pub. No.: US 2026/0173078 A1
(43) Pub. Date: Jun. 18, 2026

(54) RESOURCE CONFIGURATION FOR SIDELINK POSITIONING REFERENCE SIGNALS

(71) Applicant: Lenovo (Singapore) Pte. Limited, Singapore (SG)

(72) Inventors: Karthikeyan Ganesan, Nauheim (DE); Robin Rajan Thomas, Bad Nauheim (DE); Abir Ben Hadj Fredj, Wiesbaden (DE)

(73) Assignee: Lenovo (Singapore) Pte. Limited, Singapore (SG)

(21) Appl. No.: 19/111,540

(22) PCT Filed: Sep. 28, 2023
(86) PCT No.: PCT/IB2023/059721

§ 371 Date: Mar. 13, 2025

Related U.S. Application Data
(60) Provisional application No. 63/411,484, filed on Sep. 29, 2022.

(51) Int. Cl. H04W 72/20

(52) U.S. Cl. CPC H04W 72/20

(57) ABSTRACT

Various aspects of the present disclosure relate to an apparatus, such as a transmitting user equipment (UE) (e.g., a target UE) that receives, from a base station, a sidelink (SL) positioning reference signal (PRS) configuration of multiple resource sets. The transmitting UE also receives, from an anchor UE, a SL-PRS resource in at least one of a UE-specific resource element offset or a frequency offset. The transmitting UE transmits, to the anchor UE, a determined candidate SL-PRS resource for PRS transmission within a resource set of the multiple resource sets.

### RELATED APPLICATION

This application claims priority to U.S. Provisional Application Ser. No. 63/411,484 filed Sep. 29, 2022 entitled “Resource Configuration for Sidelink Positioning Reference Signals,” the disclosure of which is incorporated by reference herein in its entirety.

### TECHNICAL FIELD

The present disclosure relates to wireless communications, and more specifically to sidelink positioning reference signals (PRSs).

### BACKGROUND

A wireless communications system may include one or multiple network communication devices, such as base stations, which may be otherwise known as an eNodeB (eNB), a next-generation NodeB (gNB), or other suitable terminology. Each of the network communication devices, such as a base station, may support wireless communications for one or multiple user communication devices, which may be otherwise known as user equipment (UE), or other suitable terminology. The wireless communications system may support wireless communications with one or multiple user communication devices by utilizing resources of the wireless communications system, such as time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

A wireless communications system includes a network-based positioning framework, which enables UE-assisted and UE-based positioning methods. However, the conventional network-based positioning does not support UE-to-UE relative positioning, ranging, and orientation determinations, which would facilitate relative positioning applications across other various services, such as for vehicle-to-everything (V2X), public safety, industrial Internet of things (IIoT), commercial, and other applications.

### SUMMARY

The present disclosure relates to methods, apparatuses, and systems that support resource configuration for sidelink PRSs. By utilizing the described techniques, multiple sidelink PRS resource sets can be configured to be confined within a time and frequency resource of a positioning resource pool, and each of the sidelink PRS resource sets include one or more sidelink (SL)-PRS resources and can be configured with a PRS symbol length and a PRS comb size. Sidelink control information (SCI) can contain a time-frequency positioning resource within a resource set, a resource set identifier (ID), a comb pattern, a resource-element offset, and a table index describing the frequency offset k′ as a function of a symbol number within the sidelink PRS resource set (i.e., at each symbol a different resource element (RE) offset is used). Additionally, higher layer can provide a PRS resource pool ID, a comb pattern, and a PRS symbol length in the time domain to the mode-2 candidate resource allocation procedure to select a SL-PRS candidate resource. The SL-PRS candidate resource can report to the higher layer the resource element offset and/or frequency offset corresponding to the comb pattern.

Further aspects of the disclosure are directed to comb pattern configuration, where multiple comb patterns configured in a resource set or in a resource pool may be time division multiplexed (TDMed) in different time slots to avoid any overlap between them. Alternatively, different non-overlapping resource element offset and/or frequency offset k′ may be used in the same time slot to accommodate different comb patterns. With reference to PRS aggregation, a transmitting UE can signal the PRS sub-bands combination to be aggregated by a receiver UE from one or more resource sets and/or from one or more resource pools or a combination thereof using the sidelink control information to aid wideband PRS measurement at the receiver UE. The described aspects of resource configuration for sidelink PRSs provide for reliable and efficient sidelink wireless communications between UEs.

In some implementations of the method and apparatuses described herein, a transmitting UE (e.g., a target UE) receives, from a base station, a SL-PRS configuration of multiple resource sets, and receives, from an anchor UE, a SL-PRS resource in at least one of a UE-specific resource element offset or a frequency offset. The transmitting UE transmits, to the anchor UE, a determined candidate SL-PRS resource for PRS transmission within a resource set of the multiple resource sets.

Some implementations of the method and apparatuses described herein may further include the sidelink PRS configuration received from the base station includes the multiple resource sets that each contain a comb pattern, a PRS length, and a reference point associated with mapping in a resource pool. The transmitting UE determines the candidate SL-PRS resource for the PRS transmission within the resource set based at least in part on the comb pattern and the PRS length. The SL-PRS resource received from the anchor UE includes a table index of a mapping of the at least one UE-specific resource element offset or the frequency offset for a comb pattern as a function of a symbol number within the SL-PRS resource. Each symbol within the SL-PRS resource has a different resource element offset. The transmitting UE reports the determined candidate SL-PRS resource that includes a combination of a resource element and frequency offset corresponding to a comb pattern and a time-frequency resource. The transmitting UE configures PRS hopping using multiple PRS sub-bands configured within one or more of the multiple resource sets. The transmitting UE configures multiple comb patterns in the resource set, wherein each comb pattern is time-division multiplexed.

In some implementations of the method and apparatuses described herein, a transmitting UE (e.g., an anchor UE) receives, from a base station, a SL-PRS configuration of multiple resource sets, and receives, from a target UE, at least one of a UE-specific resource element offset or a frequency offset for transmission of a SL-PRS resource to the target UE. The transmitting UE transmits, to the target UE, a determined candidate SL-PRS resource for PRS transmission within a resource set of the multiple resource sets.

Some implementations of the method and apparatuses described herein may further include the sidelink PRS configuration received from the base station includes the multiple resource sets that each contain a comb pattern, a PRS length, and a reference point associated with mapping in a resource pool. The transmitting UE determines the candidate SL-PRS resource for the PRS transmission within the resource set based at least in part on the comb pattern and the PRS length. The transmitting UE reports the determined candidate SL-PRS resource that includes a combination of a resource element and frequency offset corresponding to a comb pattern and a time-frequency resource. The transmitting UE configures PRS hopping using multiple PRS sub-bands configured within one or more of the multiple resource sets. The transmitting UE configures multiple comb patterns in the resource set, wherein each comb pattern is time-division multiplexed.

In some implementations of the method and apparatuses described herein, a network entity (NE), such as a base station, receives a SL-PRS configuration of multiple resource sets, and transmits the SL-PRS configuration of the multiple resource sets to one or more UEs. Some implementations of the method and apparatuses described herein may further include the SL-PRS configuration includes the multiple resource sets that each contain a comb pattern, a PRS length, and a reference point associated with mapping in a resource pool.

### BRIEF DESCRIPTION OF THE DRAWINGS

FIG. 1 illustrates an example of a wireless communications system that supports resource configuration for sidelink PRSs in accordance with aspects of the present disclosure.

FIG. 2 illustrates an example of a positioning resource pool with PRS resource sets, which supports resource configuration for sidelink PRSs in accordance with aspects of the present disclosure.

FIG. 3 illustrates an example of a partial staggered mapping showing comb-4 of PRS length three (3), which supports resource configuration for sidelink PRSs in accordance with aspects of the present disclosure.

FIG. 4 illustrates an example of a PRS slot structure that supports resource configuration for sidelink PRSs in accordance with aspects of the present disclosure.

FIG. 5 illustrates an example of a mixed slot structure that supports resource configuration for sidelink PRSs in accordance with aspects of the present disclosure.

FIG. 6 illustrates an example of PRS repetition within a slot, which supports resource configuration for sidelink PRSs in accordance with aspects of the present disclosure.

FIGS. 7 and 8 illustrate an example of a block diagram of devices that supports resource configuration for sidelink PRSs in accordance with aspects of the present disclosure.

FIGS. 9 through 13 illustrate flowcharts of methods that support resource configuration for sidelink PRSs in accordance with aspects of the present disclosure.

### DETAILED DESCRIPTION

A wireless communications system includes a network-based positioning framework, which enables UE-assisted and UE-based positioning methods. However, the conventional network-based positioning does not support UE-to-UE relative positioning, ranging, and orientation determinations, which would facilitate relative positioning applications across other various services, such as for V2X, public safety, industrial IIoT, commercial, and other applications, such as for in-coverage, partial coverage, and out-of-coverage scenarios. Traditionally for network-based positioning, LMF configures downlink (DL)-PRS through DL-PFL and DL-PRS resources to the target or initiator UE over location protocol (LPP) containing PRS configurations received from serving and neighboring gNBs, positioning type (e.g., AoA, round trip time (RTT), TDOA, etc.), and measurement reporting. The DL-PRS can be transmitted in beams, and a DL-PRS beam is referred to as a DL-PRS resource, while the full set of PRS beams transmitted from a TRP on the same frequency is referred to as a DL PRS resource set. A comb pattern and muting pattern are configured per resource set.

In aspects of resource configuration for sidelink PRSs, this disclosure describes details for the configuration of the SL-PRS resource configuration within a resource pool (e.g., a comb pattern, a muting pattern and how it affects the mode-1 and mode-e RA procedure, and SL-PRS resource aggregation for wideband measurement). At a high-level, each SL-PRS resource set can start at any subchannel in a resource pool and can be configured with a PRS bandwidth ranging from minimum and maximum subchannel size in steps of subchannel size within a resource pool. Multiple PRS resource sets can be configured within a resource pool, and each of the resource sets can be configured with a comb pattern, muting pattern, etc. In another option, SL-PRS resource starting, ending, and multiple comb patterns can be configured within a positioning resource pool. Additionally, Mode-1 and Mode-2 RA can be taken into a consideration for the described options.

In further aspects of resource configuration for sidelink PRSs, and with reference to PRS resource set configuration in a resource pool, multiple sidelink PRS resource sets can be configured to be confined within a time and frequency resource of a positioning resource pool, and each of the sidelink PRS resource sets include one or more SL-PRS resources and can be configured with a PRS symbol length and a PRS comb size. A SCI can contain a time-frequency positioning resource within a resource set, a resource set ID, a comb pattern, a resource-element offset, and a table index describing the frequency offset k′ as a function of a symbol number within the sidelink PRS resource set (i.e., at each symbol a different RE offset is used). Additionally, higher layer can provide a PRS resource pool ID, a comb pattern, and a PRS symbol length in the time domain to the mode-2 candidate resource allocation procedure to select a SL-PRS candidate resource. The SL-PRS candidate resource can report to the higher layer the resource element offset and/or frequency offset corresponding to the comb pattern.

In further aspects, and with reference to comb pattern configuration, multiple comb patterns configured in a resource set or in a resource pool may be TDMed in different time slots to avoid any overlap between them. Alternatively, different non-overlapping resource element offset and/or frequency offset k′ may be used in the same time slot to accommodate different comb patterns. With reference to PRS aggregation, a transmitting UE can signal the PRS sub-bands combination to be aggregated by a receiver UE from one or more resource sets and/or from one or more resource pools or a combination thereof using the sidelink control information to aid wideband PRS measurement at the receiver UE.

Aspects of the present disclosure are described in the context of a wireless communications system. Aspects of the present disclosure are further illustrated and described with reference to device diagrams and flowcharts.

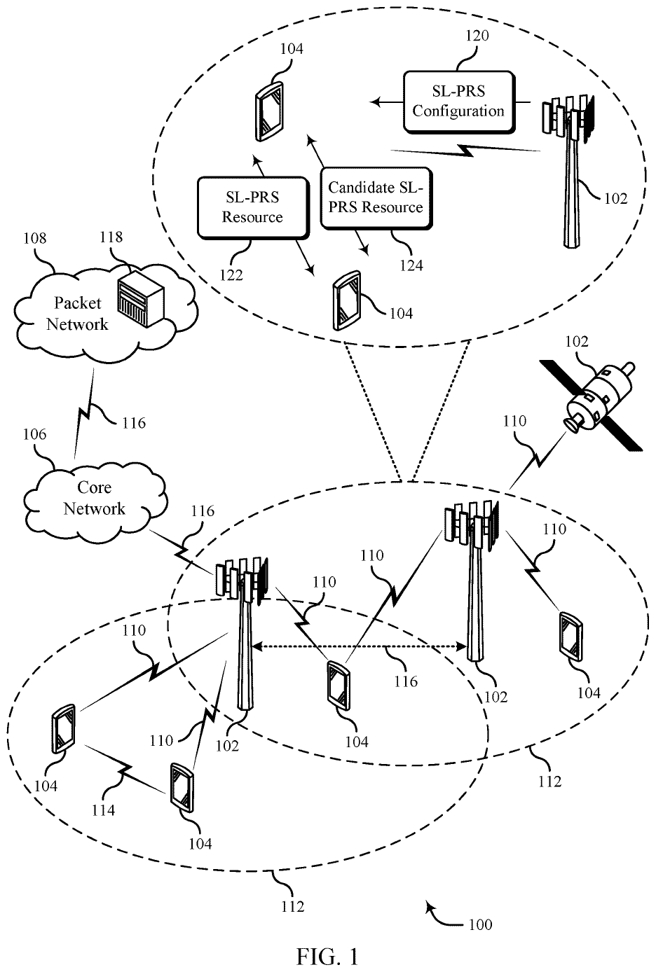

FIG. 1 illustrates an example of a wireless communications system 100 that supports resource configuration for sidelink PRSs in accordance with aspects of the present disclosure. The wireless communications system 100 may include one or more network entities 102, one or more UEs 104, a core network 106, and a packet data network 108. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a 5G network, such as an NR network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G. Additionally, the wireless communications system 100 may support technologies, such as time division multiple access (TDMA), frequency division multiple access (FDMA), or code division multiple access (CDMA), etc.

The one or more network entities 102 may be dispersed throughout a geographic region to form the wireless communications system 100. One or more of the network entities 102 described herein may be or include or may be referred to as a network node, a base station, a network element, a radio access network (RAN), a base transceiver station, an access point, a NodeB, an eNodeB (eNB), a next-generation NodeB (gNB), or other suitable terminology. A network entity 102 and a UE 104 may communicate via a communication link 110, which may be a wireless or wired connection. For example, a network entity 102 and a UE 104 may perform wireless communication (e.g., receive signaling, transmit signaling) over a Uu interface.

A network entity 102 may provide a geographic coverage area 112 for which the network entity 102 may support services (e.g., voice, video, packet data, messaging, broadcast, etc.) for one or more UEs 104 within the geographic coverage area 112. For example, a network entity 102 and a UE 104 may support wireless communication of signals related to services (e.g., voice, video, packet data, messaging, broadcast, etc.) according to one or multiple radio access technologies. In some implementations, a network entity 102 may be moveable, for example, a satellite associated with a non-terrestrial network. In some implementations, different geographic coverage areas 112 associated with the same or different radio access technologies may overlap, but the different geographic coverage areas 112 may be associated with different network entities 102. Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The one or more UEs 104 may be dispersed throughout a geographic region of the wireless communications system 100. A UE 104 may include or may be referred to as a mobile device, a wireless device, a remote device, a remote unit, a handheld device, or a subscriber device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples. In some implementations, a UE 104 may be stationary in the wireless communications system 100. In some other implementations, a UE 104 may be mobile in the wireless communications system 100.

The one or more UEs 104 may be devices in different forms or having different capabilities. Some examples of UEs 104 are illustrated in FIG. 1. A UE 104 may be capable of communicating with various types of devices, such as the network entities 102, other UEs 104, or network equipment (e.g., the core network 106, the packet data network 108, a relay device, an integrated access and backhaul (IAB) node, or another network equipment), as shown in FIG. 1. Additionally, or alternatively, a UE 104 may support communication with other network entities 102 or UEs 104, which may act as relays in the wireless communications system 100.

A UE 104 may also be able to support wireless communication directly with other UEs 104 over a communication link 114. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link 114 may be referred to as a sidelink. For example, a UE 104 may support wireless communication directly with another UE 104 over a PC5 interface.

A network entity 102 may support communications with the core network 106, or with another network entity 102, or both. For example, a network entity 102 may interface with the core network 106 through one or more backhaul links 116 (e.g., via an S1, N2, or another network interface). The network entities 102 may communicate with each other over the backhaul links 116 (e.g., via an X2, Xn, or another network interface). In some implementations, the network entities 102 may communicate with each other directly (e.g., between the network entities 102). In some other implementations, the network entities 102 may communicate with each other or indirectly (e.g., via the core network 106). In some implementations, one or more network entities 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

In some implementations, a network entity 102 may be configured in a disaggregated architecture, which may be configured to utilize a protocol stack physically or logically distributed among two or more network entities 102, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 102 may include one or more of a central unit (CU), a distributed unit (DU), a radio unit (RU), a RAN Intelligent Controller (RIC) (e.g., a Near-Real Time RIC (Near-RT RIC), a Non-Real Time RIC (Non-RT RIC)), a Service Management and Orchestration (SMO) system, or any combination thereof.

An RU may also be referred to as a radio head, a smart radio head, a remote radio head (RRH), a remote radio unit (RRU), or a transmission reception point (TRP). One or more components of the network entities 102 in a disaggregated RAN architecture may be co-located, or one or more components of the network entities 102 may be located in distributed locations (e.g., separate physical locations). In some implementations, one or more network entities 102 of a disaggregated RAN architecture may be implemented as virtual units (e.g., a virtual CU (VCU), a virtual DU (VDU), a virtual RU (VRU)).

Split of functionality between a CU, a DU, and an RU may be flexible and may support different functionalities depending upon which functions (e.g., network layer functions, protocol layer functions, baseband functions, radio frequency functions, and any combinations thereof) are performed at a CU, a DU, or an RU. For example, a functional split of a protocol stack may be employed between a CU and a DU such that the CU may support one or more layers of the protocol stack and the DU may support one or more different layers of the protocol stack. In some implementations, the CU may host upper protocol layer (e.g., a layer 3 (L3), a layer 2 (L2)) functionality and signaling (e.g., Radio Resource Control (RRC), service data adaption protocol (SDAP), Packet Data Convergence Protocol (PDCP)). The CU may be connected to one or more DUs or RUs, and the one or more DUs or RUs may host lower protocol layers, such as a layer 1 (L1) (e.g., physical (PHY) layer) or an L2 (e.g., radio link control (RLC) layer, medium access control (MAC) layer) functionality and signaling, and may each be at least partially controlled by the CU.

Additionally, or alternatively, a functional split of the protocol stack may be employed between a DU and an RU such that the DU may support one or more layers of the protocol stack and the RU may support one or more different layers of the protocol stack. The DU may support one or multiple different cells (e.g., via one or more RUs). In some implementations, a functional split between a CU and a DU, or between a DU and an RU may be within a protocol layer (e.g., some functions for a protocol layer may be performed by one of a CU, a DU, or an RU, while other functions of the protocol layer are performed by a different one of the CU, the DU, or the RU).

A CU may be functionally split further into CU control plane (CU-CP) and CU user plane (CU-UP) functions. A CU may be connected to one or more DUs via a midhaul communication link (e.g., F1, F1-c, F1-u), and a DU may be connected to one or more RUs via a fronthaul communication link (e.g., open fronthaul (FH) interface). In some implementations, a midhaul communication link or a fronthaul communication link may be implemented in accordance with an interface (e.g., a channel) between layers of a protocol stack supported by respective network entities 102 that are in communication via such communication links.

The core network 106 may support user authentication, access authorization, tracking, connectivity, and other access, routing, or mobility functions. The core network 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a Packet Data Network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more network entities 102 associated with the core network 106.

The core network 106 may communicate with the packet data network 108 over one or more backhaul links 116 (e.g., via an S1, N2, or another network interface). The packet data network 108 may include an application server 118. In some implementations, one or more UEs 104 may communicate with the application server 118. A UE 104 may establish a session (e.g., a protocol data unit (PDU) session, or the like) with the core network 106 via a network entity 102. The core network 106 may route traffic (e.g., control information, data, and the like) between the UE 104 and the application server 118 using the established session (e.g., the established PDU session). The PDU session may be an example of a logical connection between the UE 104 and the core network 106 (e.g., one or more network functions of the core network 106).

In the wireless communications system 100, the network entities 102 and the UEs 104 may use resources of the wireless communications system 100, such as time resources (e.g., symbols, slots, subframes, frames, or the like) or frequency resources (e.g., subcarriers, carriers) to perform various operations (e.g., wireless communications). In some implementations, the network entities 102 and the UEs 104 may support different resource structures. For example, the network entities 102 and the UEs 104 may support different frame structures. In some implementations, such as in 4G, the network entities 102 and the UEs 104 may support a single frame structure. In some other implementations, such as in 5G and among other suitable radio access technologies, the network entities 102 and the UEs 104 may support various frame structures (i.e., multiple frame structures). The network entities 102 and the UEs 104 may support various frame structures based on one or more numerologies.

One or more numerologies may be supported in the wireless communications system 100, and a numerology may include a subcarrier spacing and a cyclic prefix. A first numerology (e.g., μ=0) may be associated with a first subcarrier spacing (e.g., 15 kHz) and a normal cyclic prefix. The first numerology (e.g., μ=0) associated with the first subcarrier spacing (e.g., 15 kHz) may utilize one slot per subframe. A second numerology (e.g., μ=1) may be associated with a second subcarrier spacing (e.g., 30 kHz) and a normal cyclic prefix. A third numerology (e.g., μ=2) may be associated with a third subcarrier spacing (e.g., 60 kHz) and a normal cyclic prefix or an extended cyclic prefix. A fourth numerology (e.g., μ=3) may be associated with a fourth subcarrier spacing (e.g., 120 kHz) and a normal cyclic prefix. A fifth numerology (e.g., μ=4) may be associated with a fifth subcarrier spacing (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally or alternatively, a time interval of a resource (e.g., a communication resource) may be organized according to slots. For example, a subframe may include a number (e.g., quantity) of slots. Each slot may include a number (e.g., quantity) of symbols (e.g., orthogonal frequency division multiplexing (OFDM) symbols). In some implementations, the number (e.g., quantity) of slots for a subframe may depend on a numerology. For a normal cyclic prefix, a slot may include 14 symbols. For an extended cyclic prefix (e.g., applicable for 60 kHz subcarrier spacing), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first subcarrier spacing (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHz-7.125 GHz), FR2 (24.25 GHz-52.6 GHz), FR3 (7.125 GHz-24.25 GHz), FR4 (52.6 GHz-114.25 GHZ), FR4a or FR4-1 (52.6 GHz-71 GHz), and FR5 (114.25 GHz-300 GHz). In some implementations, the network entities 102 and the UEs 104 may perform wireless communications over one or more of the operating frequency bands. In some implementations, FR1 may be used by the network entities 102 and the UEs 104, among other equipment or devices for cellular communications traffic (e.g., control information, data). In some implementations, FR2 may be used by the network entities 102 and the UEs 104, among other equipment or devices for short-range, high data rate capabilities.

FRI may be associated with one or multiple numerologies (e.g., at least three numerologies). For example, FR1 may be associated with a first numerology (e.g., μ=0), which includes 15 kHz subcarrier spacing; a second numerology (e.g., μ=1), which includes 30 kHz subcarrier spacing; and a third numerology (e.g., μ=2), which includes 60 kHz subcarrier spacing. FR2 may be associated with one or multiple numerologies (e.g., at least 2 numerologies). For example, FR2 may be associated with a third numerology (e.g., μ=2), which includes 60 kHz subcarrier spacing; and a fourth numerology (e.g., μ=3), which includes 120 kHz subcarrier spacing.

According to implementations, one or more of the network entities 102 and the UEs 104 are operable to implement various aspects of resource configuration for sidelink PRSs, as described herein. For instance, a network entity 102 (e.g., a base station) communicates a SL-PRS configuration 120 of multiple resource sets to UEs 104. In at least one implementation, the SL-PRS configuration 120 includes multiple resource sets that each contain a comb pattern, a PRS length, and a reference point associated with mapping in a resource pool. A transmitting UE (e.g., a target UE) receives the SL-PRS configuration 120 of the multiple resource sets from the base station (e.g., a network entity 102), and receives, from an anchor UE 104, a SL-PRS resource 122 in at least one of a UE-specific resource element offset or a frequency offset. The transmitting UE transmits, to the anchor UE, a determined candidate SL-PRS resource 124 for PRS transmission within a resource set of the multiple resource sets. In another implementation, a transmitting UE (e.g., an anchor UE) receives the SL-PRS configuration 120 of the multiple resource sets from the base station, and receives, from a target UE 104, at least one of a UE-specific resource element offset or a frequency offset for transmission of a SL-PRS resource 122 to the target UE. The transmitting UE transmits, to the target UE, a determined candidate SL-PRS resource 124 for PRS transmission within a resource set of the multiple resource sets.

With reference to positioning solutions, the DL-PRS configuration contains PRS resource, resource set, frequency layer, repetition, beam information, etc. There can be at most four frequency layers and each frequency layer has at most 64 TRPs. Each TRP per frequency layer can have two DL-PRS resource sets, thus resulting in a total of eight resource sets per TRP and each resource set can have up to 64 resources. Each resource corresponds to a beam. Having two different resource sets per frequency layer per TRP allows gNB to configure one set of wide beams and another set of narrow beams for each frequency layer.

The PRS footprint on the time frequency grid is configurable with a starting physical resource block (PRB) and a PRS bandwidth. The PRS may start at any PRB in the system bandwidth and can be configured with a bandwidth ranging from 24 to 276 PRBs in steps of four PRBs. This amounts to a maximum bandwidth of about 100 MHz for 30 kHz subcarrier spacing and to about 400 MHz for 120 kHz subcarrier spacing. The flexible bandwidth configuration allows the network to configure the PRS while keeping out of band emissions to an acceptable level. The large bandwidth allows a very significant improvement in time-of-arrival (TOA) accuracy compared to LTE.

The PRS can be transmitted in beams. A PRS beam is referred to as a PRS resource, while the full set of PRS beams transmitted from a TRP on the same frequency is referred to as a PRS resource set. The different beams can be time-multiplexed across symbols or slots. To assist UE receive (RX) beamforming, the DL-PRS can be configured to be quasi-co-located (QCL) Type D with a DL reference signal from a serving or neighboring cell, signaling that the same RX beam used by the UE to receive the reference signal can be used to receive the configured PRS. The beam structure of the PRS improves coverage, especially for mm-wave deployments, and also allows for AoD estimation (e.g., the UE can measure DL-PRS received signal time difference (RSTD) per beam and report the measured RSTD including DL-PRS resource ID (beam ID) to the LMF.

In order to improve positioning accuracy, more measurements can be collected, and the measurements are collected per resource. Hence, repeated transmission of PRS resources helps to collect more measurements, which can be collected per resource. The repetition of resources can be done in two ways, repeat before sweep, and sweep before repeat. The amount and type of repetition can be configured with parameters for configuring the gaps between resources (TPRS gap) and the number of resource repetition (TPRS rep) within a period of resource set (TPRS per). The DL PRS resources can be repeated up to 32 times within a resource set period, either in consecutive slots or with a configurable gap between repetitions. The resource set period in FRI ranges from 4 to 10240 milli-seconds.

The DL-PRS is designed to allow the UE to perform accurate TOA measurements in the presence of interfering DL-PRSs from nearby TRPs. Each symbol of the DL PRS has a comb-structure in frequency (i.e., the PRS utilizes every Nth subcarrier). The comb value N can be configured to be 2, 4, 6, or 12. The length of the PRS within one slot is a multiple of N symbols and the position of the first symbol within a slot is flexible as long as the slot consists of at least N PRS symbols. It allows accumulation of contiguous sub-carriers across a slot which improves correlation properties for TOA estimation. The resource element pattern can be shifted in frequency with a frequency offset of 0 to N−1 subcarriers, thus allowing N orthogonal DL-PRS utilizing the same symbols. All configurable patterns cover every subcarrier in the configured bandwidth over the pattern duration, which gives a maximum measurement range for the TOA measurement in scenarios with large delay spreads. The DL-PRS is quadrature phase shift keying (QPSK) modulated by a standardized 31-bit goldcode sequence initialized based on a DL-PRS sequence ID taking values from 0 to 4095.

Besides a comb structure allowing multiplexing of multiple TRPs in a slot, muting of signals can also be used as a way to mitigate interference. The muting can be used either at the repetition level, where each repetition can be individually muted within a periodic occasion, or at the occasion level, where the whole periodic DL-PRS occasion (including all repetitions) can be muted. The supported positioning techniques in Rel-16 are listed in Table 1.

TABLE 1
Supported Rel-16 UE positioning methods

| | | UE- | | |
|---|---|---|---|---|
| | | assisted, | NG-RAN | |
| | UE- | LMF- | node | |
| Method | based | based | assisted | SUPL |
| A-GNSS | Yes | Yes | No | Yes (UE-based and |
| | | | | UE-assisted) |
| OTDOA ^{Note 1, Note 2} | No | Yes | No | Yes (UE-assisted) |
| E-CID ^{Note 4} | No | Yes | Yes | Yes for E-UTRA |
| | | | | (UE-assisted) |
| Sensor | Yes | Yes | No | No |
| WLAN | Yes | Yes | No | Yes |
| Bluetooth | No | Yes | No | No |
| TBS ^{Note 5} | Yes | Yes | No | Yes (MBS) |
| DL-TDOA | Yes | Yes | No | No |
| DL-AoD | Yes | Yes | No | No |
| Multi-RTT | No | Yes | Yes | No |
| NR E-CID | No | Yes | FFS | No |
| UL-TDOA | No | No | Yes | No |
| UL-AoA | No | No | Yes | No |

^{Note 1}
This includes TBS positioning based on PRS signals.
^{Note 2}
In this version of the specification only OTDOA based on LTE signals is supported.
NOTE 3:
Void.
^{Note 4}
This includes Cell-ID for NR method.
^{Note 5}
In this version of the specification only for TBS positioning based on MBS signals.
NOTE 6:
Void

Separate positioning techniques can be configured and performed based on the requirements of the LMF and UE capabilities. The transmission of PRS enable the UE to perform UE positioning-related measurements to enable the computation of a UE's location estimate and are configured per transmission reception point (TRP), where a TRP may transmit one or more beams.

In aspects of this disclosure, 3GPP RAN1 Rel18 agreements are taken into consideration. With reference to RAN1 #109-e agreement, a new reference signal for SL positioning and ranging uses the existing PRS/sounding reference signal (SRS) design and SL design framework as a starting point. Considerations include at least sequence design, frequency domain pattern, time domain pattern (e.g., number of symbols, repetitions, etc.), and time domain behavior, as well as configuration, triggering, activation, and de-activation of the SL-PRS, automatic gain control (AGC) time, Tx-Rx turnaround time, supportable bandwidth(s), multiplexing options with other SL channels, and randomization and/or orthogonalization options. Note that the study of an existing SL reference signal for SL positioning and ranging is not precluded. Companies are encouraged to perform performance evaluations and comparisons to investigate whether such reference signals can meet the positioning accuracy requirements.

With regards to the frequency domain pattern, considerations include the comb-N SL-PRS design. Considerations include at least the aspects of N>=1 (where N=1 corresponds to full RE mapping pattern); a fully staggered SL-PRS pattern (e.g., M symbols of SL-PRS with comb-N with M=N and, at each symbol a different RE offset is used); partially staggered SL-PRS pattern (e.g., M symbol(s) of SL-PRS with comb-N, with M<N, at each symbol a different RE offset is used); unstaggered SL-PRS patterns (e.g., M symbol(s) of SL-PRS with comb-N, at each symbol a same RE offset is used, N>1). The number of symbols of SL-PRS within a slot, with any relation to the comb-N option and RE offset pattern repetitions within a slot, and for further study (FFS), other frequency domain pattern(s).

With reference to RAN1 #110-e agreement and terminology, a target UE is a UE to be positioned (in this context, using SL, i.e., PC5 interface). Sidelink positioning is positioning a UE using reference signals transmitted over SL (i.e., PC5 interface), to obtain absolute position, relative position, or ranging information. Ranging is a determination of the distance and/or the direction between a UE and another entity (e.g., an anchor UE). A sidelink positioning reference signal (SL-PRS) is a reference signal transmitted over SL for positioning purposes. SL-PRS (pre-) configuration is configured or pre-configured parameters of SL-PRS, such as time-frequency resources (other parameters are not precluded) including its bandwidth and periodicity. An anchor UE is a UE supporting positioning of a target UE (e.g., by transmitting and/or receiving reference signals for positioning, providing positioning-related information, etc., over the SL interface. FFS is a clarification of the knowledge of the location of the anchor UE.

Other considerations include RTT-type solutions using SL, taking into account both single-sided (also known as one-way) and double-sided (also known as two-way) RTT. The SL-AoA includes both azimuth of arrival (AoA) and zenith of arrival (ZoA) in the study. The SL-time difference of arrival (TDOA). The SL-AoD corresponds to a method, where reference signal received power (RSRP) and/or RSRPP measurements similar to the DL-AoD method in Uu, and include both azimuth of departure (AoD) and zenith of departure (ZoD) in the study. Reuse NR SL numerologies (FR1 and FR2, noting that this does not imply that SL-PRS specific optimizations will be considered). New SL-PRS design includes a sequence design, frequency domain pattern, time domain pattern (e.g., number of symbols, repetitions, etc.), and time domain behavior, as well as configuration, triggering, activation, and/or de-activation of the SL-PRS, AGC time, Tx-Rx turnaround time, supportable bandwidth(s), multiplexing options with other SL channels, and randomization and/or orthogonalization options.

With regards to the positioning methods supported using at least SL measurements, potential candidate positioning methods include at least RTT-type solution(s) using SL, SL-AoA, and SL-TDOA. Note that other methods can still be studied, and the above categorization does not necessarily mean that there will be separate SL positioning methods specified.

A new reference signal should be introduced for supporting SL positioning and ranging. For the sequence of the new reference signal for SL positioning and ranging, down select between Alt 1 and Alt 2, where Alt. 1 is pseudo-random-based. Use existing sequence of DL-PRS as a starting point. Alt. 2 is Zadoff-Chu (ZC) sequence-based (SRS sequence as a starting point). With regards to the frequency domain pattern, a comb-N SL-PRS occupying M symbol(s) design should be introduced for the support of NR SL positioning. Noting that there could be multiple values for M, N. With regards to the frequency domain pattern for multi-symbol SL-PRS, prioritize partially and fully staggered SL-PRS. Noting that this does not preclude comb N=1, and FFS is single symbol SL-PRS, if supported.

Regarding SL-PRS resource allocation, both Scheme 1 and Scheme 2 should be introduced for supporting SL positioning and ranging. For Scheme 1, network-centric operation SL-PRS resource allocation (e.g., similar to a legacy Mode 1 solution), and the network (e.g., gNB, LMF, gNB & LMF) allocates resources for SL-PRS. For Scheme 2, UE autonomous SL-PRS resource allocation (e.g., similar to legacy Mode 2 solution), and at least one of the UE(s) participating in the sidelink positioning operation allocates resources for SL-PRS. With regards to the sidelink positioning resource allocation, one of the following alternatives should be introduced for supporting SL positioning and ranging: for alternative one, only dedicated resource pool(s) can be configured or pre-configured for SL-PRS, and for alternative two, either dedicated resource pool(s) and/or a shared resource pool(s) with sidelink communication can be configured or pre-configured for SL-PRS. Noting that whether other signals or channels can be present in the dedicated resource pool can be further discussed.

With reference to SL positioning resource allocation (2), in a scheme 1, network-centric operation SL-PRS resource allocation (e.g., similar to a legacy Mode 1 solution) and the network (e.g., gNB, LMF, gNB & LMF) allocates resources for SL-PRS. In a scheme 2, a UE autonomous SL-PRS resource allocation (e.g., similar to legacy Mode 2 solution), where at least one of the UE(s) participating in the sidelink positioning operation allocates resources for SL-PRS and applicable regardless of the network coverage. For FFS, potential mechanisms, if needed, for SL-PRS resource coordination across a number of transmitting UEs (e.g., IUC-like solutions). Noting that other schemes are not precluded to be studied, and FFS how to handle resource allocation of SL positioning measurement report.

With reference to configuration, activation, deactivation, and/or triggering of SL-PRS, an option one is high-layer-only signaling involvement in the SL-PRS configuration, with no lower layer involvement (e.g., SL-medium access control element (MAC-CE) or SCI or downlink control information (DCI), for the activation or the triggering of a SL-PRS), and based on the study, this option may correspond to a SL-PRS configuration that is a single-shot or multiple shots, and/or a high-layer configuration that may be received from an LMF, a gNB, or a UE. An option two is high-layer and lower-layer signaling involvement in the SL-PRS configuration, with lower-layer may correspond to SL-MAC-CE, or SCI, or DCI. For example, high layer signaling can may be used for SL-PRS configuration and lower layer signaling can be used for initiating SL positioning and/or configuration, triggering, activating, deactivating, and/or indicating and potential resource indication or reservation transmission of SL-PRS.

In aspects of resource configuration for sidelink PRSs, this disclosure describes details for the configuration of the SL-PRS resource configuration within a resource pool (e.g., a comb pattern, a muting pattern and how it affects the mode-1 and mode-e radio access (RA) procedure, and SL-PRS resource aggregation for wideband measurement). At a high-level, each SL-PRS resource set can start at any subchannel in a resource pool and can be configured with a PRS bandwidth ranging from minimum and maximum subchannel size in steps of subchannel size within a resource pool. Multiple PRS resource sets can be configured within a resource pool, and each of the resource sets can be configured with a comb pattern, muting pattern, etc. In another option, SL-PRS resource starting, ending, and multiple comb patterns can be configured within a positioning resource pool. Additionally, Mode-1 and Mode-2 RA can be taken into a consideration for the described options.

In further aspects of resource configuration for sidelink PRSs, and with reference to PRS resource set configuration in a resource pool, multiple sidelink PRS resource sets can be configured to be confined within a time and frequency resource of a positioning resource pool, and each of the sidelink PRS resource sets include one or more SL-PRS resources and can be configured with a PRS symbol length and a PRS comb size. A SCI can contain a time-frequency positioning resource within a resource set, a resource set ID, a comb pattern, a resource-element offset, and a table index describing the frequency offset k′ as a function of a symbol number within the sidelink PRS resource set (i.e., at each symbol a different RE offset is used). Additionally, higher layer can provide a PRS resource pool ID, a comb pattern, and a PRS symbol length in the time domain to the mode-2 candidate resource allocation procedure to select a SL-PRS candidate resource. The SL-PRS candidate resource can report to the higher layer the resource element offset and/or frequency offset corresponding to the comb pattern.

In further aspects, and with reference to comb pattern configuration, multiple comb patterns configured in a resource set or in a resource pool may be TDMed in different time slots to avoid any overlap between them. Alternatively, different non-overlapping resource element offset and/or frequency offset k′ may be used in the same time slot to accommodate different comb patterns. With reference to PRS aggregation, a transmitting UE can signal the PRS sub-bands combination to be aggregated by a receiver UE from one or more resource sets and/or from one or more resource pools or a combination thereof using the sidelink control information to aid wideband PRS measurement at the receiver UE.

In this disclosure, the terms eNB and gNB are used as terms for a base station, but are replaceable by any other radio access node (e.g., base station (BS), eNB, gNB, access point (AP), NR, etc.). Further, aspects of the disclosure are described mainly in the context of 5G NR. However, aspects of the described techniques are equally applicable to other mobile communication systems supporting serving cells and/or carriers being configured for sidelink communication over PC5 interface.

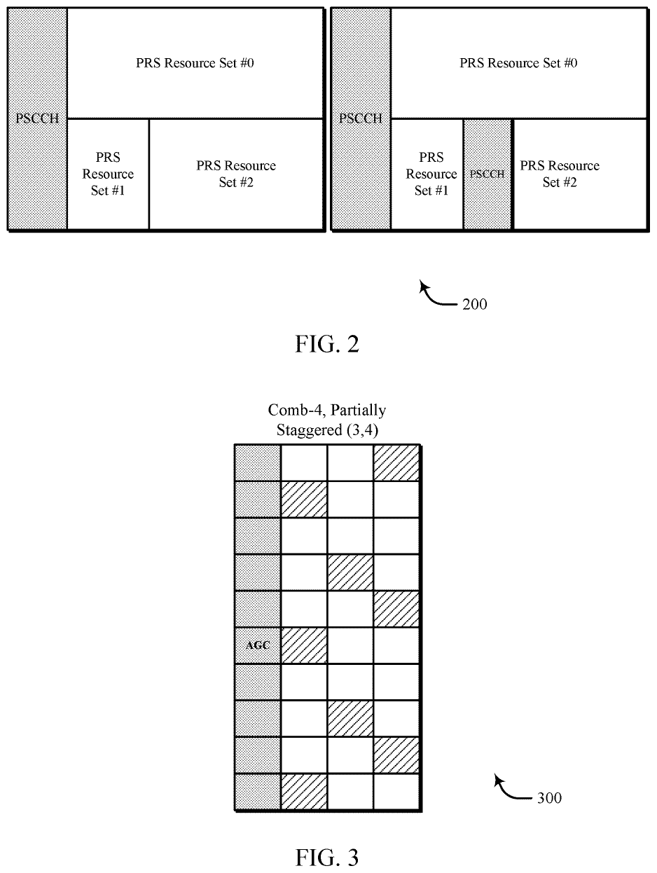

FIG. 2 illustrates an example 200 of a positioning resource pool with PRS resource sets, which supports resource configuration for sidelink PRSs in accordance with aspects of the present disclosure. With reference to PRS resource set configuration in a resource pool, multiple sidelink PRS resource sets can be configured to be confined within a time and frequency resource of a positioning resource pool, and each PRS resource set has one or more SL-PRS resources. Each PRS resource set in a resource pool can be configured or pre-configured with a time and frequency resource containing a minimum number of subchannels, a start subchannel number, an end subchannel number, a step size for the resource set bandwidth, thereby providing placement of a PRS resource set within a positioning resource pool. A SL-PRS resource can be mapped in a time-frequency resource element (K, L) in a PRB within an allocation provided within a resource set, such as according to:

$${a}_{k , l}^{( p , μ )} = {β}_{P R S} r ( m )$$

$$m = 0 , 1 , …$$

$$k = m {K}_{c o m b}^{P R S} + ( ( {k}_{off set}^{P R S} + {k}^{′} ) mod {K}_{c o m b}^{P R S} )$$

$$l = {l}_{start}^{P R S} , {l}_{start}^{P R S} + 1 , … , {l}_{start}^{P R S} + {L}_{P R S} - 1$$

when the following conditions are fulfilled: the resource element (k, l)_{p,μ} is within the resource blocks occupied by the SL-PRS resource for which a UE is configured, and

$${l}_{start}^{P R S}$$

is the first symbol of the SL-PRS within a resource set of a position resource pool.

The SL-PRS resource can be confined within a time-frequency resource of a resource set, which in turn can be confined within a positioning resource pool. However, physical sidelink control channel (PSCCH) occupies 10, 12, or 24 PRBs in a sub-channel, and if PSCCH is transmitted along with SL-PRS, then one sub-channel is the minimum to be allocated for SL-PRS transmission. As shown in the example 200, the multiple PRS resource sets configured in a positioning resource pool can be time-division multiplexed (TDMed) or frequency-division multiplexed (FDMed), and/or may be fully or partially overlapped in time and frequency. Explicitly signaling the resource set ID along with the PRS resource activation can be used to identify the PRS resource within one of these PRS resource sets.

Each PRS resource set can be configured with one or more parameters, such as a size of the sidelink PRS resource in the time domain, for example—L_{PRS} ∈{2,4,6,12}; the comb size

$${K}_{c o m b}^{P R S} ∈ \{ 2 , 4 , 6 , 12 \} ;$$

a combination of one value of

$$\{ {L}_{PRS} , {K}_{c o m b}^{P R S} \}$$

may be configured in a resource set; a muting pattern configuration and muting repetition factor; as well as periodicity, slot offset, time gap, and/or PRS repetition factor. The resource-element offset

$${k}_{offset}^{P R S} ∈ \{ 0 , 1 , … , {K}_{c o m b}^{P R S} - 1 \}$$

can be signaled to the UE as part of the PRS resource configuration or as part of the activation message, or autonomously selected using the sensing mechanism. The reference point for k=0 is the location of the point A of the positioning resource pool, in which the SL-PRS resource is configured where point A is given by the higher-layer parameter. Each resource set is allocated a unique identifier to uniquely identify the resource set in a sidelink carrier or a sidelink bandwidth part or a sidelink positioning frequency layer. A gNB or a LMF can configure a sidelink UE with one or more resource sets and then activate a positioning resource within a resource set from the positioning resource pool using a UE specific signaling.

There is also a mapping between the positioning QoS, such as for accuracy, latency, and the resource set can be configured and signaled to the UE, so that the UE selects the resource set according to the positioning QoS. In an example, each of the resource sets can be assigned a priority value or a range of priority value, and these priority values are related to positioning QoS.

FIG. 3 illustrates an example 300 of a partial staggered mapping showing comb-4 of PRS length three (3), which supports resource configuration for sidelink PRSs in accordance with aspects of the present disclosure. In implementations, SCI can include a time-frequency positioning resource within a resource set, a resource set ID, a comb pattern, a resource-element offset per UE, and a table index that indicates a frequency offset k′ as a function of symbol number within the sidelink PRS resource (i.e., at each symbol, a different RE offset is used to map a particular comb size at a different symbol. A combination of values of

$$\{ {L}_{PRS} , {K}_{c o m b}^{P R S} \}$$

can include values considering a fully staggered SL-PRS pattern (e.g., M symbols of SL-PRS with comb-N with M=N and, at each symbol a different RE offset is used), and considering a partially staggered SL-PRS pattern (e.g., M symbol(s) of SL-PRS with comb-N, with M<N and, at each symbol a different RE offset is used).

TABLE 2
The frequency offset k' as a function of symbol number

| | $Symbol number within the downlink PRS resource l - {l}_{start}^{PRS}$ | | | | | | | | | | | |
|---|---|---|---|---|---|---|---|---|---|---|---|---|
| ${K}_{c o m b}^{P R S}$ | 0 | 1 | 2 | 3 | 4 | 5 | 6 | 7 | 8 | 9 | 10 | 11 |
| 2 | 0 | 1 | 0 | 1 | 0 | 1 | 0 | 1 | 0 | 1 | 0 | 1 |
| 4 | 0 | 2 | 1 | 3 | 0 | 2 | 1 | 3 | 0 | 2 | 1 | 3 |
| 6 | 0 | 3 | 1 | 4 | 2 | 5 | 0 | 3 | 1 | 4 | 2 | 5 |
| 12 | 0 | 6 | 3 | 9 | 1 | 7 | 4 | 10 | 2 | 8 | 5 | 11 |
| 8 | 0 | 4 | 2 | 6 | 1 | 5 | 3 | 7 | 0 | 4 | 2 | 6 |
| 10 | 0 | 5 | 2 | | | | | | | | | |

In an example, the quantity k′ is given by Table 2 for each comb pattern providing RE offset for each symbol number. In an option 1, each of the PRS resource sets can be configured with a PRS symbol length and a PRS comb size. In an option 2, each of the PRS resource sets can be configured with multiple PRS symbol lengths, where in one example, the PRS symbol length is configured with a multiple of a PRS symbol lengths (i.e., PRS symbol length 2, 4, 8, etc., or PRS symbol length 4, 8, 12, etc.). A resource set can be configured with one or more comb size. However, a dedicated activation message activates a PRS resource containing a symbol length and a comb size from the configuration.

In an implementation, the higher layer can provide a PRS resource pool ID, a PRS resource set ID (i.e., assuming that the comb pattern is configured per resource set), a PRS symbol length in the time domain, a PRS symbol length, and a PRS bandwidth to the mode-2 candidate resource allocation procedure to select SL-PRS candidate resources. The candidate resource corresponding to the indicated resource pool ID and the resource set ID can be reported to the higher layer containing the resource element offset and/or frequency offset of the comb pattern and time-frequency resource.

In another implementation, the network (gNB or a LMF) can configure multiple resource sets to the UE, and the activation message transmitted using the lower layer signaling activates a PRS resource within a resource set containing a PRS length, a comb pattern, and a table index describing the frequency offset k′ as a function of symbol number within the sidelink PRS resource (i.e., at each symbol a different RE offset is used).

In an alternate implementation, a comb pattern can be configured as part of the positioning resource pool (with no resource set configuration in the resource pool). One or more of the comb patterns can be configured as part of the positioning resource pool and then the positioning resource pool can also be configured with one or more parameters, such as a size of the sidelink PRS resource in the time domain, for example—L_{PRS} ∈{2,4,6,12}; the comb size

$${K}_{c o m b}^{P R S} ∈ \{ 2 , 4 , 6 , 12 \} ;$$

a combination of one value of

$$\{ {L}_{PRS} , {K}_{c o m b}^{P R S} \}$$

may be configured in a resource set; a muting pattern configuration and muting repetition factor; and one or more of periodicity, slot offset, time gap, and PRS repetition factor.

The resource-element offset

$${k}_{offset}^{P R S} ∈ \{ 0 , 1 , … , {K}_{c o m b}^{P R S} - 1 \}$$

can be signaled to the UE as part of the PRS resource configuration, as part of the activation message, or configured as part of the resource pool or autonomously selected using the sensing mechanism. In an implementation, a gNB or a LMF can configure a sidelink UE with multiple PRS resources containing a comb pattern, a PRS length, a resource element offset and/or frequency offset, a PRS bandwidth, and may activate one of these PRS resources containing a comb pattern, PRS length, resource element offset and/or frequency offset, or a table index describing the frequency offset k′ as a function of symbol number within the sidelink PRS resource (i.e., at each symbol a different RE offset is used). In another implementation, the higher layer can provide a PRS resource pool ID, a comb pattern, and a PRS symbol length in the time domain to the mode-2 candidate resource allocation procedure to select a SL-PRS candidate resource. The SL-PRS candidate resource can report to the higher layer the resource element offset and/or frequency offset corresponding to the comb pattern.

With reference to PRS slot structure, the multiple comb patterns configured in a resource set or in a resource pool may be TDMed in a different time slot to avoid any overlap between them. Otherwise, different non-overlapping resource element offset and/or frequency offset k′ as a function of symbol number within the sidelink PRS resource (i.e., at each symbol a different RE offset) can be used in the same time slot to accommodate different comb size patterns.

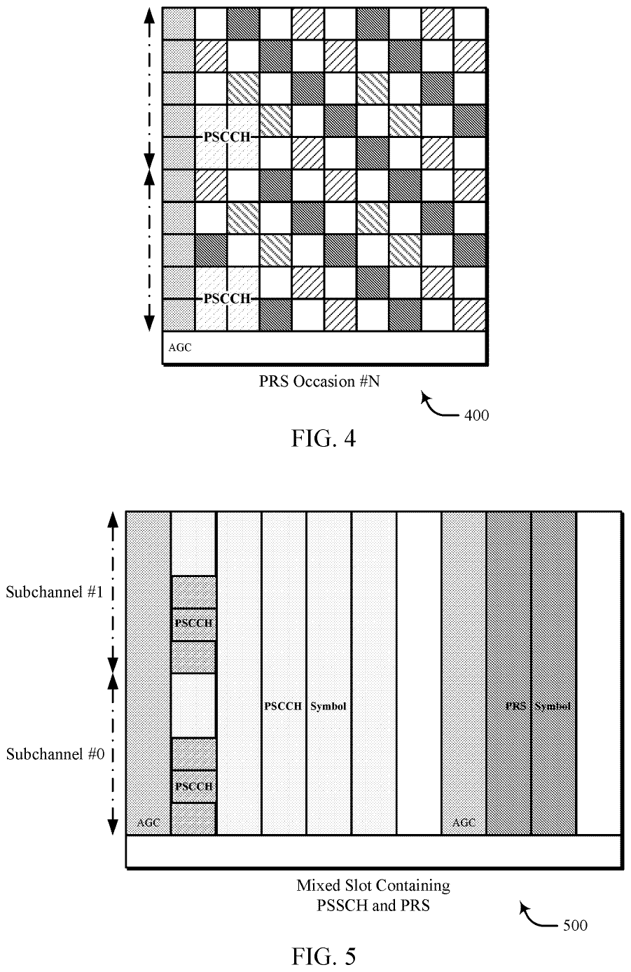

FIG. 4 illustrates an example 400 of a PRS slot structure that supports resource configuration for sidelink PRSs in accordance with aspects of the present disclosure. The PRS slot structure can be configured in a dedicated PRS resource pool, or there is a dedicated PRS slot within a shared resource pool. In the case of shared resource pool, the time domain bitmap within a resource pool indicates PRS slot. As shown in the example 400, a first symbol is an AGC symbol which spans up to the PRS bandwidth so that a receiver UE may tune to receive wider PRS bandwidth. The PRBs of PSCCH can be configured or pre-configured in a resource pool occupying PRBs within a subchannel, if PSCCH is present. The PRS can be FDMed with the PSCCH in the remaining PRBs, otherwise the remaining PRBs of a PSCCH symbol within a subchannel are left empty or filled with the 2^{nd} SCI content transmitted in the PSCCH or PSSCH region.

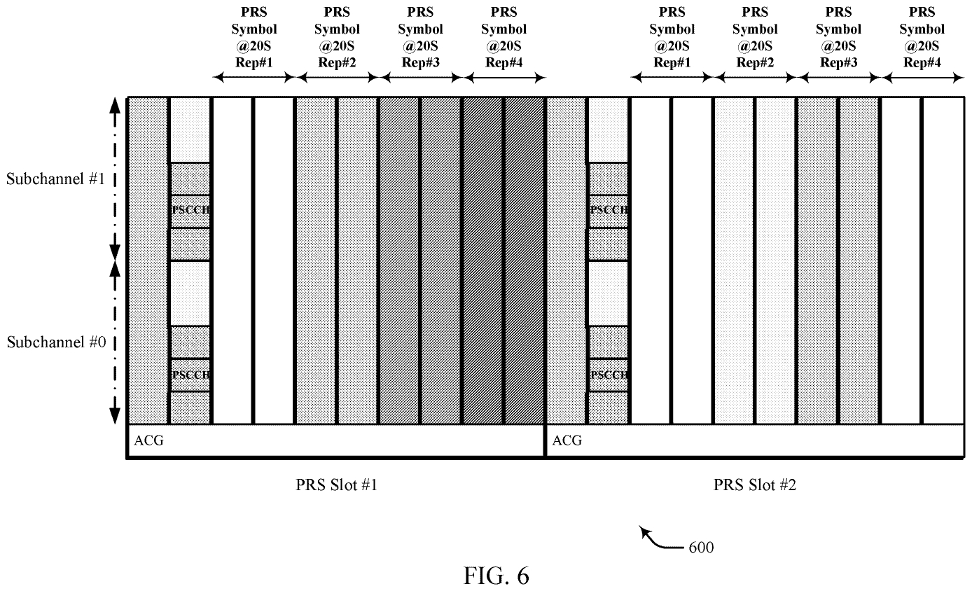

FIG. 5 illustrates an example 500 of a mixed slot structure that supports resource configuration for sidelink PRSs in accordance with aspects of the present disclosure. Similar to a physical sidelink feedback channel (PSFCH) configuration, the PRS can be configured to occupancy 2, 4 OFDM symbol towards the end of the slot. In this case, the slot may contain PSCCH followed by physical sidelink shared channel (PSSCH), which is followed by a gap symbol, and then an AGC symbol followed by a PRS symbol, as shown in the example 500. The PRS period can be configured in a resource pool. The bitmap of PRBs or subchannel in a shared resource pool indicates the PRS frequency domain resource.

FIG. 6 illustrates an example 600 of PRS repetition within a slot, which supports resource configuration for sidelink PRSs in accordance with aspects of the present disclosure. The sidelink Rel16 does not support mini slot concept for SL data transmission. However, the DL PRS supports from 2 OFDM symbol length, which is similar to mini slot. A PSCCH resource is present at the beginning of every slot for SL data in Rel16, as shown in the example 600. In this case, different PRS symbol length is supported and the shorter PRS symbol length may be repeated until the end of the slot. The SCI can contain the number of repetitions within a slot, and PRS symbol length. In an option 1, the repetition does not span across slots, and thus finishes at the slot boundary or in the resource pool slot boundary. In an option 2, repetition spans across a slot, however PSCCH is present at the beginning of the slot, and residual repetition is indicated in the second slot. In an option 3 for multi-slot scheduling, one PSCCH scheduling multiple PRS, including repetition, spans across multiple slots.

With reference to PRS aggregation, multiple PRS sub-bands can be configured within one or more resource sets, or within a resource pool, sidelink bandwidth part (BWP), or sidelink frequency layer depending on the hierarchical SL-PRS resource relationship. Additionally, SL-PRS frequency hopping for a UE can be configured using multiple SL-PRS sub-bands from one or more resource sets and/or from one or more resource pools, or a combination thereof. The PRS sub-bands across one or more resource sets belonging to one or more resource pools can be configured.

A transmitter UE (e.g., a transmit UE or an anchor UE) can signal the PRS sub-bands combination to be aggregated by the receiver UE from one or more resource sets and/or from one or more resource pools, or a combination thereof, using the sidelink control information to aid wideband PRS measurement at the receiver UE. In an example, each sub-band can be provided with an index, and the bitmap of an index can be signaled in the SCI as part of coherent combining. The set of frequency hopping patterns can be configured as part of the resource pool and the index of the hopping pattern can be signaled in SCI to the receiver UE.

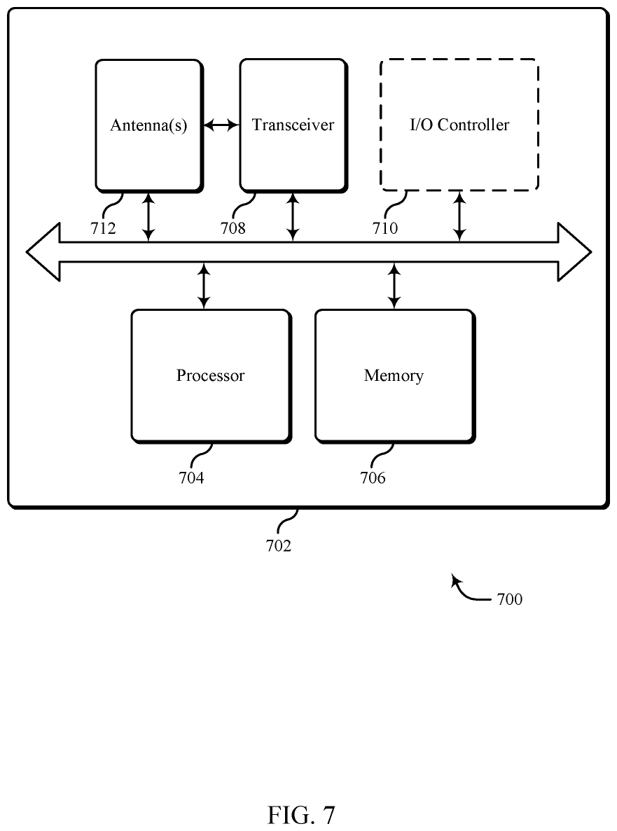

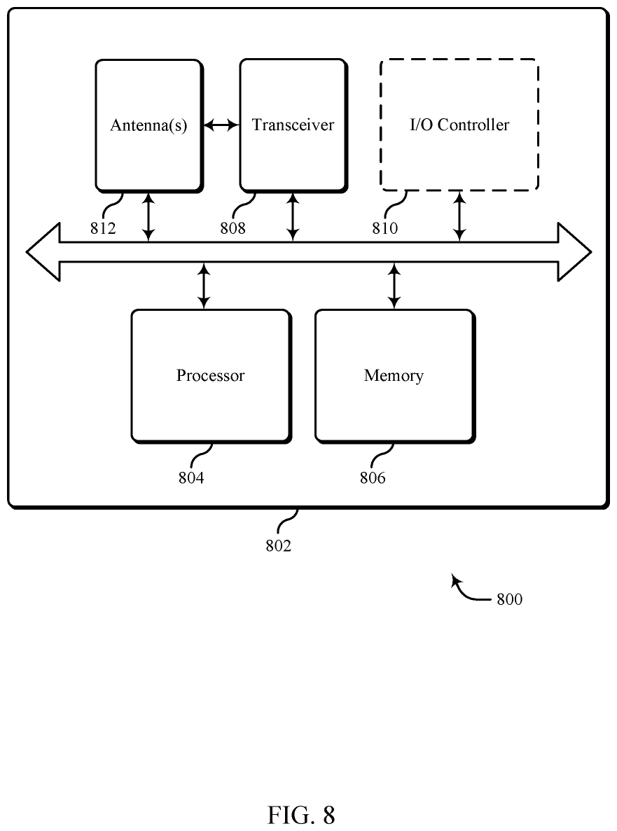

FIG. 7 illustrates an example of a block diagram 700 of a device 702 that supports resource configuration for sidelink PRSs in accordance with aspects of the present disclosure. The device 702 may be an example of a UE 104, such as a transmitting UE (e.g., a target UE, or an anchor UE) as described herein. The device 702 may support wireless communication with one or more network entities 102, UEs 104, or any combination thereof. The device 702 may include components for bi-directional communications including components for transmitting and receiving communications, such as a processor 704, a memory 706, a transceiver 708, and an I/O controller 710. These components may be in electronic communication or otherwise coupled (e.g., operatively, communicatively, functionally, electronically, electrically) via one or more interfaces (e.g., buses).

The processor 704, the memory 706, the transceiver 708, or various combinations thereof or various components thereof may be examples of means for performing various aspects of the present disclosure as described herein. For example, the processor 704, the memory 706, the transceiver 708, or various combinations or components thereof may support a method for performing one or more of the operations described herein.

In some implementations, the processor 704, the memory 706, the transceiver 708, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 704 and the memory 706 coupled with the processor 704 may be configured to perform one or more of the functions described herein (e.g., executing, by the processor 704, instructions stored in the memory 706).

For example, the processor 704 may support wireless communication at the device 702 in accordance with examples as disclosed herein. The processor 704 may be configured as or otherwise support a means for receiving, from a base station, a first signaling as a SL-PRS configuration of multiple resource sets; receiving, from an anchor UE, a second signaling as a SL-PRS resource in at least one of a UE-specific resource element offset or a frequency offset; and transmitting, to the anchor UE, a third signaling as a determined candidate SL-PRS resource for PRS transmission within a resource set of the multiple resource sets.

Additionally, the processor 704 may be configured as or otherwise support any one or combination of the sidelink PRS configuration received from the base station includes the multiple resource sets that each contain a comb pattern, a PRS length, and a reference point associated with mapping in a resource pool. The method further comprising determining the candidate SL-PRS resource for the PRS transmission within the resource set based at least in part on the comb pattern and the PRS length. The SL-PRS resource received from the anchor UE includes a table index of a mapping of the at least one UE-specific resource element offset or the frequency offset for a comb pattern as a function of a symbol number within the SL-PRS resource. Each symbol within the SL-PRS resource has a different resource element offset. The method further comprising reporting the determined candidate SL-PRS resource that includes a combination of a resource element and frequency offset corresponding to a comb pattern and a time-frequency resource. The method further comprising configuring PRS hopping using multiple PRS sub-bands configured within one or more of the multiple resource sets. The method further comprising configuring multiple comb patterns in the resource set, wherein each comb pattern is time-division multiplexed.

Additionally, or alternatively, the device 702, in accordance with examples as disclosed herein, may include a processor and a memory coupled with the processor, the processor configured to cause the apparatus to receive, from a base station, a first signaling as a SL-PRS configuration of multiple resource sets; receive, from an anchor UE, a second signaling as a SL-PRS resource in at least one of a UE-specific resource element offset or a frequency offset; and transmit, to the anchor UE, a third signaling as a determined candidate SL-PRS resource for PRS transmission within a resource set of the multiple resource sets.

Additionally, the wireless communication at the device 702 may include any one or combination of the sidelink PRS configuration received from the base station includes the multiple resource sets that each contain a comb pattern, a PRS length, and a reference point associated with mapping in a resource pool. The processor is configured to cause the apparatus to determine the candidate SL-PRS resource for the PRS transmission within the resource set based at least in part on the comb pattern and the PRS length. The SL-PRS resource received from the anchor UE includes a table index of a mapping of the at least one UE-specific resource element offset or the frequency offset for a comb pattern as a function of a symbol number within the SL-PRS resource. Each symbol within the SL-PRS resource has a different resource element offset. The processor is configured to cause the apparatus to report the determined candidate SL-PRS resource that includes a combination of a resource element and frequency offset corresponding to a comb pattern and a time-frequency resource. The processor is configured to cause the apparatus to configure PRS hopping using multiple PRS sub-bands configured within one or more of the multiple resource sets. The processor is configured to cause the apparatus to configure multiple comb patterns in the resource set, wherein each comb pattern is time-division multiplexed.

In another example, the processor 704 may support wireless communication at the device 702 in accordance with examples as disclosed herein. The processor 704 may be configured as or otherwise support a means for receiving, from a base station, a first signaling as a SL-PRS configuration of multiple resource sets; receiving, from a target UE, a second signaling as at least one of a UE-specific resource element offset or a frequency offset for transmission of a SL-PRS resource to the target UE; and transmitting, to the target UE, a third signaling as a determined candidate SL-PRS resource for PRS transmission within a resource set of the multiple resource sets.

Additionally, the processor 704 may be configured as or otherwise support any one or combination of the sidelink PRS configuration received from the base station includes the multiple resource sets that each contain a comb pattern, a PRS length, and a reference point associated with mapping in a resource pool. The method further comprising determining the candidate SL-PRS resource for the PRS transmission within the resource set based at least in part on the comb pattern and the PRS length. The method further comprising reporting the determined candidate SL-PRS resource that includes a combination of a resource element and frequency offset corresponding to a comb pattern and a time-frequency resource. The method further comprising configuring PRS hopping using multiple PRS sub-bands configured within one or more of the multiple resource sets. The method further comprising configuring multiple comb patterns in the resource set, wherein each comb pattern is time-division multiplexed.

Additionally, or alternatively, the device 702, in accordance with examples as disclosed herein, may include a processor and a memory coupled with the processor, the processor configured to cause the apparatus to receive, from a base station, a first signaling as a SL-PRS configuration of multiple resource sets; receive, from a target UE, a second signaling as at least one of a UE-specific resource element offset or a frequency offset for transmission of a SL-PRS resource to the target UE; and transmit, to the target UE, a third signaling as a determined candidate SL-PRS resource for PRS transmission within a resource set of the multiple resource sets.

Additionally, the wireless communication at the device 702 may include any one or combination of the sidelink PRS configuration received from the base station includes the multiple resource sets that each contain a comb pattern, a PRS length, and a reference point associated with mapping in a resource pool. The processor is configured to cause the apparatus to determine the candidate SL-PRS resource for the PRS transmission within the resource set based at least in part on the comb pattern and the PRS length. The processor is configured to cause the apparatus to report the determined candidate SL-PRS resource that includes a combination of a resource element and frequency offset corresponding to a comb pattern and a time-frequency resource. The processor is configured to cause the apparatus to configure PRS hopping using multiple PRS sub-bands configured within one or more of the multiple resource sets. The processor is configured to cause the apparatus to configure multiple comb patterns in the resource set, wherein each comb pattern is time-division multiplexed.

The processor 704 of the device 702, such as a UE 104, may support wireless communication in accordance with examples as disclosed herein. The processor 704 includes at least one controller coupled with at least one memory, and is configured to or operable to cause the processor to receive a first signaling as a SL-PRS configuration of multiple resource sets; receive, from an anchor UE, a second signaling as a SL-PRS resource in at least one of a UE-specific resource element offset or a frequency offset; and transmit, to the anchor UE, a third signaling as a determined candidate SL-PRS resource for PRS transmission within a resource set of the multiple resource sets. Additionally, or alternatively, the sidelink PRS configuration includes the multiple resource sets that each contain a comb pattern, a PRS length, and a reference point associated with mapping in a resource pool. The at least one controller is configured to cause the processor to determine the candidate SL-PRS resource for the PRS transmission within the resource set based at least in part on the comb pattern and the PRS length. The SL-PRS resource received from the anchor UE includes a table index of a mapping of the at least one UE-specific resource element offset or the frequency offset for a comb pattern as a function of a symbol number within the SL-PRS resource.

The processor 704 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 704 may be configured to operate a memory array using a memory controller. In some other implementations, a memory controller may be integrated into the processor 704. The processor 704 may be configured to execute computer-readable instructions stored in a memory (e.g., the memory 706) to cause the device 702 to perform various functions of the present disclosure.

The memory 706 may include random access memory (RAM) and read-only memory (ROM). The memory 706 may store computer-readable, computer-executable code including instructions that, when executed by the processor 704 cause the device 702 to perform various functions described herein. The code may be stored in a non-transitory computer-readable medium such as system memory or another type of memory. In some implementations, the code may not be directly executable by the processor 704 but may cause a computer (e.g., when compiled and executed) to perform functions described herein. In some implementations, the memory 706 may include, among other things, a basic I/O system (BIOS) which may control basic hardware or software operation such as the interaction with peripheral components or devices.

The I/O controller 710 may manage input and output signals for the device 702. The I/O controller 710 may also manage peripherals not integrated into the device M02. In some implementations, the I/O controller 710 may represent a physical connection or port to an external peripheral. In some implementations, the I/O controller 710 may utilize an operating system such as iOS®, ANDROID®, MS-DOS®, MS-WINDOWS®, OS/2®, UNIX®, LINUX®, or another known operating system. In some implementations, the I/O controller 710 may be implemented as part of a processor, such as the processor 704. In some implementations, a user may interact with the device 702 via the I/O controller 710 or via hardware components controlled by the I/O controller 710.

In some implementations, the device 702 may include a single antenna 712. However, in some other implementations, the device 702 may have more than one antenna 712 (i.e., multiple antennas), including multiple antenna panels or antenna arrays, which may be capable of concurrently transmitting or receiving multiple wireless transmissions. The transceiver 708 may communicate bi-directionally, via the one or more antennas 712, wired, or wireless links as described herein. For example, the transceiver 708 may represent a wireless transceiver and may communicate bi-directionally with another wireless transceiver. The transceiver 708 may also include a modem to modulate the packets, to provide the modulated packets to one or more antennas 712 for transmission, and to demodulate packets received from the one or more antennas 712.

FIG. 8 illustrates an example of a block diagram 800 of a device 802 that supports resource configuration for sidelink PRSs in accordance with aspects of the present disclosure. The device 802 may be an example of a network entity 102, such as a base station, as described herein. The device 802 may support wireless communication with one or more network entities 102, UEs 104, or any combination thereof. The device 802 may include components for bi-directional communications including components for transmitting and receiving communications, such as a processor 804, a memory 806, a transceiver 808, and an I/O controller 810. These components may be in electronic communication or otherwise coupled (e.g., operatively, communicatively, functionally, electronically, electrically) via one or more interfaces (e.g., buses).

The processor 804, the memory 806, the transceiver 808, or various combinations thereof or various components thereof may be examples of means for performing various aspects of the present disclosure as described herein. For example, the processor 804, the memory 806, the transceiver 808, or various combinations or components thereof may support a method for performing one or more of the operations described herein.

In some implementations, the processor 804, the memory 806, the transceiver 808, or various combinations or components thereof may be implemented in hardware (e.g., in communications management circuitry). The hardware may include a processor, a digital signal processor (DSP), an application-specific integrated circuit (ASIC), a field-programmable gate array (FPGA) or other programmable logic device, a discrete gate or transistor logic, discrete hardware components, or any combination thereof configured as or otherwise supporting a means for performing the functions described in the present disclosure. In some implementations, the processor 804 and the memory 806 coupled with the processor 804 may be configured to perform one or more of the functions described herein (e.g., executing, by the processor 804, instructions stored in the memory 806).

For example, the processor 804 may support wireless communication at the device 802 in accordance with examples as disclosed herein. The processor 804 may be configured as or otherwise support a means for receiving a first signaling as a SL-PRS configuration of multiple resource sets; and transmitting a second signaling as the SL-PRS configuration of the multiple resource sets to one or more UEs.

Additionally, the processor 804 may be configured as or otherwise support any one or combination of the SL-PRS configuration includes the multiple resource sets that each contain a comb pattern, a PRS length, and a reference point associated with mapping in a resource pool.

Additionally, or alternatively, the device 802, in accordance with examples as disclosed herein, may include a processor and a memory coupled with the processor, the processor configured to cause the apparatus to receive a first signaling as a SL-PRS configuration of multiple resource sets; and transmit a second signaling as the SL-PRS configuration of the multiple resource sets to one or more UEs.

Additionally, the wireless communication at the device 802 may include any one or combination of the SL-PRS configuration includes the multiple resource sets that each contain a comb pattern, a PRS length, and a reference point associated with mapping in a resource pool.

The processor 804 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some implementations, the processor 804 may be configured to operate a memory array using a memory controller. In some other implementations, a memory controller may be integrated into the processor 804. The processor 804 may be configured to execute computer-readable instructions stored in a memory (e.g., the memory 806) to cause the device 802 to perform various functions of the present disclosure.

The memory 806 may include random access memory (RAM) and read-only memory (ROM). The memory 806 may store computer-readable, computer-executable code including instructions that, when executed by the processor 804 cause the device 802 to perform various functions described herein. The code may be stored in a non-transitory computer-readable medium such as system memory or another type of memory. In some implementations, the code may not be directly executable by the processor 804 but may cause a computer (e.g., when compiled and executed) to perform functions described herein. In some implementations, the memory 806 may include, among other things, a basic I/O system (BIOS) which may control basic hardware or software operation such as the interaction with peripheral components or devices.

The I/O controller 810 may manage input and output signals for the device 802. The I/O controller 810 may also manage peripherals not integrated into the device M02. In some implementations, the I/O controller 810 may represent a physical connection or port to an external peripheral. In some implementations, the I/O controller 810 may utilize an operating system such as iOS®, ANDROID®, MS-DOS®, MS-WINDOWS®, OS/2®, UNIX®, LINUX®, or another known operating system. In some implementations, the I/O controller 810 may be implemented as part of a processor, such as the processor 804. In some implementations, a user may interact with the device 802 via the I/O controller 810 or via hardware components controlled by the I/O controller 810.

In some implementations, the device 802 may include a single antenna 812. However, in some other implementations, the device 802 may have more than one antenna 812 (i.e., multiple antennas), including multiple antenna panels or antenna arrays, which may be capable of concurrently transmitting or receiving multiple wireless transmissions. The transceiver 808 may communicate bi-directionally, via the one or more antennas 812, wired, or wireless links as described herein. For example, the transceiver 808 may represent a wireless transceiver and may communicate bi-directionally with another wireless transceiver. The transceiver 808 may also include a modem to modulate the packets, to provide the modulated packets to one or more antennas 812 for transmission, and to demodulate packets received from the one or more antennas 812.

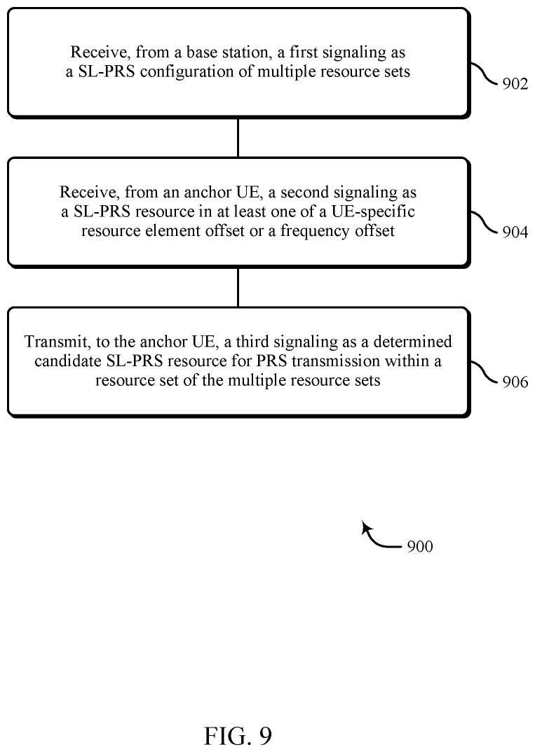

FIG. 9 illustrates a flowchart of a method 900 that supports resource configuration for sidelink PRSs in accordance with aspects of the present disclosure. The operations of the method 900 may be implemented by a device or its components as described herein. For example, the operations of the method 900 may be performed by a UE 104, such as a transmitting UE (e.g., a target UE) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 902, the method may include receiving, from a base station, a first signaling as a SL-PRS configuration of multiple resource sets. The operations of 902 may be performed in accordance with examples as described herein. In some implementations, aspects of the operations of 902 may be performed by a device as described with reference to FIG. 1.

At 904, the method may include receiving, from an anchor UE, a second signaling as a SL-PRS resource in at least one of a UE-specific resource element offset or a frequency offset. The operations of 904 may be performed in accordance with examples as described herein. In some implementations, aspects of the operations of 904 may be performed by a device as described with reference to FIG. 1.

At 906, the method may include transmitting, to the anchor UE, a third signaling as a determined candidate SL-PRS resource for PRS transmission within a resource set of the multiple resource sets. The operations of 906 may be performed in accordance with examples as described herein. In some implementations, aspects of the operations of 906 may be performed by a device as described with reference to FIG. 1.

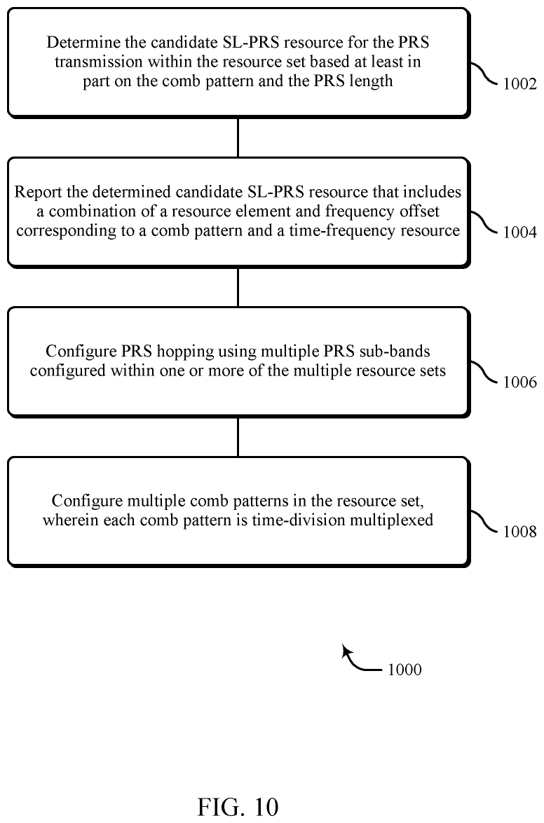

FIG. 10 illustrates a flowchart of a method 1000 that supports resource configuration for sidelink PRSs in accordance with aspects of the present disclosure. The operations of the method 1000 may be implemented by a device or its components as described herein. For example, the operations of the method 1000 may be performed by a UE 104, such as a transmitting UE (e.g., a target UE) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1002, the method may include determining the candidate SL-PRS resource for the PRS transmission within the resource set based at least in part on the comb pattern and the PRS length. The operations of 1002 may be performed in accordance with examples as described herein. In some implementations, aspects of the operations of 1002 may be performed by a device as described with reference to FIG. 1.

At 1004, the method may include reporting the determined candidate SL-PRS resource that includes a combination of a resource element and frequency offset corresponding to a comb pattern and a time-frequency resource. The operations of 1004 may be performed in accordance with examples as described herein. In some implementations, aspects of the operations of 1004 may be performed by a device as described with reference to FIG. 1.

At 1006, the method may include configuring PRS hopping using multiple PRS sub-bands configured within one or more of the multiple resource sets. The operations of 1006 may be performed in accordance with examples as described herein. In some implementations, aspects of the operations of 1006 may be performed by a device as described with reference to FIG. 1.

At 1008, the method may include configuring multiple comb patterns in the resource set, wherein each comb pattern is time-division multiplexed. The operations of 1008 may be performed in accordance with examples as described herein. In some implementations, aspects of the operations of 1008 may be performed by a device as described with reference to FIG. 1.

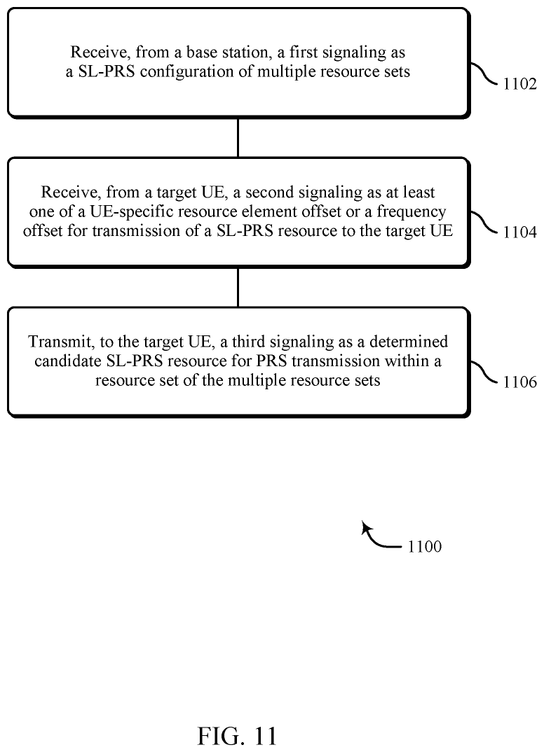

FIG. 11 illustrates a flowchart of a method 1100 that supports resource configuration for sidelink PRSs in accordance with aspects of the present disclosure. The operations of the method 1100 may be implemented by a device or its components as described herein. For example, the operations of the method 1100 may be performed by a UE 104, such as a transmitting UE (e.g., an anchor UE) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1102, the method may include receiving, from a base station, a first signaling as a SL-PRS configuration of multiple resource sets. The operations of 1102 may be performed in accordance with examples as described herein. In some implementations, aspects of the operations of 1102 may be performed by a device as described with reference to FIG. 1.

At 1104, the method may include receiving, from a target UE, a second signaling as at least one of a UE-specific resource element offset or a frequency offset for transmission of a SL-PRS resource to the target UE. The operations of 1104 may be performed in accordance with examples as described herein. In some implementations, aspects of the operations of 1104 may be performed by a device as described with reference to FIG. 1.

At 1106, the method may include transmitting, to the target UE, a third signaling as a determined candidate SL-PRS resource for PRS transmission within a resource set of the multiple resource sets. The operations of 1106 may be performed in accordance with examples as described herein. In some implementations, aspects of the operations of 1106 may be performed by a device as described with reference to FIG. 1.

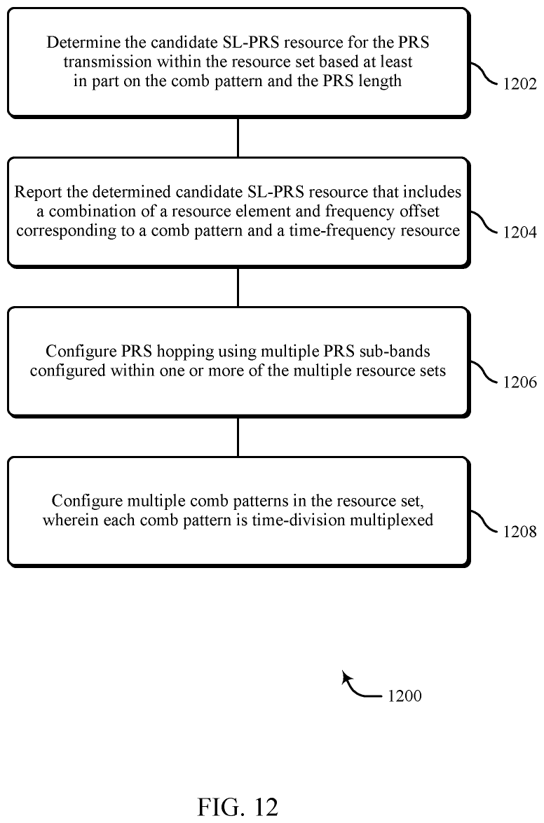

FIG. 12 illustrates a flowchart of a method 1200 that supports resource configuration for sidelink PRSs in accordance with aspects of the present disclosure. The operations of the method 1200 may be implemented by a device or its components as described herein. For example, the operations of the method 1200 may be performed by a UE 104, such as a transmitting UE (e.g., an anchor UE) as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1202, the method may include determining the candidate SL-PRS resource for the PRS transmission within the resource set based at least in part on the comb pattern and the PRS length. The operations of 1202 may be performed in accordance with examples as described herein. In some implementations, aspects of the operations of 1202 may be performed by a device as described with reference to FIG. 1.

At 1204, the method may include reporting the determined candidate SL-PRS resource that includes a combination of a resource element and frequency offset corresponding to a comb pattern and a time-frequency resource. The operations of 1204 may be performed in accordance with examples as described herein. In some implementations, aspects of the operations of 1204 may be performed by a device as described with reference to FIG. 1.

At 1206, the method may include configuring PRS hopping using multiple PRS sub-bands configured within one or more of the multiple resource sets. The operations of 1206 may be performed in accordance with examples as described herein. In some implementations, aspects of the operations of 1206 may be performed by a device as described with reference to FIG. 1.

At 1208, the method may include configuring multiple comb patterns in the resource set, wherein each comb pattern is time-division multiplexed. The operations of 1208 may be performed in accordance with examples as described herein. In some implementations, aspects of the operations of 1208 may be performed by a device as described with reference to FIG. 1.

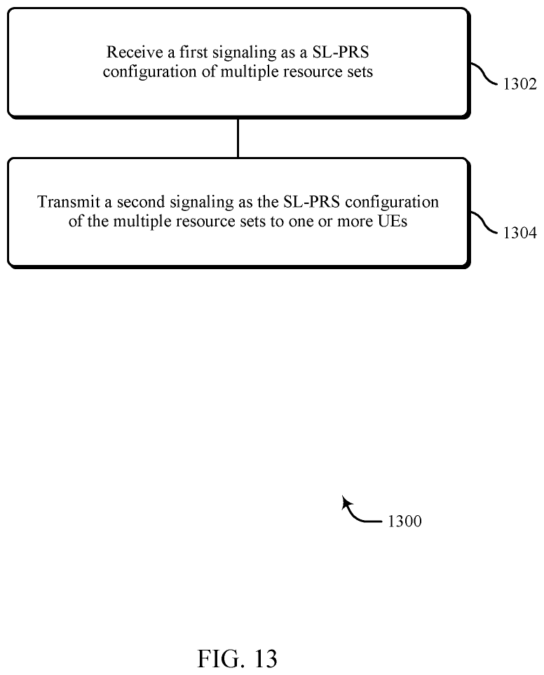

FIG. 13 illustrates a flowchart of a method 1300 that supports resource configuration for sidelink PRSs in accordance with aspects of the present disclosure. The operations of the method 1300 may be implemented by a device or its components as described herein. For example, the operations of the method 1300 may be performed by a network entity 102, such as a base station, gNB, LMF, and/or gNB & LMF as described with reference to FIGS. 1 through 8. In some implementations, the device may execute a set of instructions to control the function elements of the device to perform the described functions. Additionally, or alternatively, the device may perform aspects of the described functions using special-purpose hardware.

At 1302, the method may include receiving a first signaling as a SL-PRS configuration of multiple resource sets. The operations of 1302 may be performed in accordance with examples as described herein. In some implementations, aspects of the operations of 1302 may be performed by a device as described with reference to FIG. 1.

At 1304, the method may include transmitting a second signaling as the SL-PRS configuration of the multiple resource sets to one or more UEs. The operations of 1304 may be performed in accordance with examples as described herein. In some implementations, aspects of the operations of 1304 may be performed by a device as described with reference to FIG. 1.

It should be noted that the methods described herein describe possible implementations, and that the operations and the steps may be rearranged or otherwise modified and that other implementations are possible. Further, aspects from two or more of the methods may be combined.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration.

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor.

Any connection may be properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Similarly, a list of one or more of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

The terms “transmitting,” “receiving,” or “communicating,” when referring to a network entity, may refer to any portion of a network entity (e.g., a base station, a CU, a DU, a RU) of a RAN communicating with another device (e.g., directly or via one or more other network entities).

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form to avoid obscuring the concepts of the described example.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE) for wireless communication, comprising:
at least one memory; and
at least one processor coupled with the at least one memory and operable to cause the UE to:
receive a sidelink (SL) positioning reference signal (PRS) configuration of multiple SL-PRS resource sets, wherein one or more SL-PRS resources of each SL-PRS resource set are associated with at least one of a resource element offset or a frequency offset; and
transmit an indication of a candidate SL-PRS resource for PRS transmission within a SL-PRS resource set of the multiple SL-PRS resource sets.

2. The UE of claim 1, wherein the sidelink PRS configuration indicates one or more of a comb pattern, a PRS length, or a reference point associated with mapping in a resource pool.

3. The UE of claim 2, wherein the at least one processor is operable to cause the UE to determine the candidate SL-PRS resource for the PRS transmission within the SL-PRS resource set based at least in part on the comb pattern and the PRS length.

4. The UE of claim 1, wherein the UE is configured with a table index of a mapping of the resource element offset or the frequency offset for a comb pattern as a function of a symbol number.

5. The UE of claim 4, wherein each symbol has a different resource element offset.

6.-7. (canceled)

8. The UE of claim 1, wherein the at least one processor is operable to cause the UE to configure multiple comb patterns in the SL-PRS resource set, wherein each comb pattern is time-division multiplexed.

9-20. (canceled)

21. A method performed by a user equipment (UE), the method comprising:
receiving a sidelink (SL) positioning reference signal (PRS) configuration of multiple SL-PRS resource sets, wherein one or more SL-PRS resources of each SL-PRS resource set are associated with at least one of a resource element offset or a frequency offset; and
transmitting an indication of a candidate SL-PRS resource for PRS transmission within a SL-PRS resource set of the multiple SL-PRS resource sets.

22. The method of claim 21, wherein the sidelink PRS configuration indicates one or more of a comb pattern, a PRS length, or a reference point associated with mapping in a resource pool.

23. The method of claim 22, further comprising:
determining the candidate SL-PRS resource for the PRS transmission within the SL-PRS resource set based at least in part on the comb pattern and the PRS length.

24. The method of claim 21, wherein the UE is configured with a table index of a mapping of the resource element offset or the frequency offset for a comb pattern as a function of a symbol number.

25. The method of claim 24, wherein each symbol has a different resource element offset.

26. The method of claim 21, further comprising:
configuring multiple comb patterns in the SL-PRS resource set, wherein each comb pattern is time-division multiplexed.

27. A network entity (NE) for wireless communication, comprising:
at least one memory; and
at least one processor coupled with the at least one memory and operable to cause the NE to:
receive a sidelink (SL) positioning reference signal (PRS) configuration of multiple SL-PRS resource sets; and
transmit the SL PRS configuration of the multiple SL-PRS resource sets to one or more user equipment (UE).

28. The NE of claim 27, wherein the SL PRS configuration indicates the multiple SL-PRS resource sets each associated with one or more of a comb pattern, a PRS length, or a reference point associated with mapping in a resource pool.

29. A method for wireless communication at a network entity, the method comprising:
receiving a sidelink (SL) positioning reference signal (PRS) configuration of multiple SL-PRS resource sets; and
transmitting the SL PRS configuration of the multiple SL-PRS resource sets to one or more user equipment (UE).
